(19) United States
(12) Patent Application Publication
(10) Pub. No.: US 2012/0243133 A1
(43) Pub. Date: Sep. 27, 2012

(54) ELECTROSTATIC DISCHARGE PROTECTION CIRCUIT

(75) Inventor: Chien-Ming WU, Zhubei City (TW)

(73) Assignee: Realtek Semiconductor Corp., Hsinchu (TW)

(21) Appl. No.: 13/428,747

(22) Filed: Mar. 23, 2012

(30) Foreign Application Priority Data
Mar. 25, 2011 (TW) 100110355

(51) Int. Cl. H02H 9/04

(52) U.S. Cl. 361/56

(57) ABSTRACT

An electrostatic discharge (ESD) protection circuit is for protecting an internal circuit electrically coupled to an input/output (I/O) pad. The ESD protection circuit comprises an ESD protection unit, to be electrically coupled to the I/O pad, for enabling release of an electrostatic charge at the I/O pad to a ground terminal. The ESD protection circuit also comprises a voltage detecting unit, electrically coupled to the ESD protection unit and to be electrically coupled to the I/O pad, for detecting the presence of an ESD voltage at the I/O pad and for controlling the ESD protection unit to establish a conduction path between the I/O pad and the ground terminal when the ESD voltage is detected.

### CROSS-REFERENCE TO RELATED APPLICATION

This application claims priority to Taiwanese Application No. 100110355, filed on Mar. 25, 2011.

### BACKGROUND OF THE INVENTION

1. Field of the Invention

The invention relates to an electrostatic discharge (ESD) protection circuit, more particularly, to an ESD protection circuit with a voltage detecting mechanism.

2. Description of the Related Art

Integrated circuit products are often affected by electrostatic discharge. Since the voltage associated with electrostatic discharge, or the instantaneous current of the discharge, is of much greater magnitude than the power supply voltage (current), certain components of the integrated circuit products may be damaged. To avoid this, integrated circuit products often have some kind of internal mechanisms to protect from ESD.

Referring to FIGS. 1 and 2, an integrated circuit 90 with a conventional ESD protection mechanism comprises at least one input/output pad (I/O pad) 91, a first protecting unit 92, a second protecting unit 93, two ground pads 94, a power pad 95 and a power switch 96. The first protecting unit 92 and the second protecting unit 93 are identical in structure, and each of them has a metal oxide semiconductor-field effect transistor with a parasitic diode. As shown in FIG. 1, when a negative electrostatic discharge voltage occurs at the I/O pad 91, the charge can be directed to one of the ground pads 94 by the second protecting unit 93 to prevent damaging internal electrical components. However, as shown in FIG. 2, when a positive electrostatic discharge voltage occurs at the I/O pad 91, the charge will have to go via the first protecting unit 92, the power pad 95 or power path, the power switch 96, and finally to the other ground pad 94. The path of the positive electrostatic discharge mechanism is rather long, resulting in the high parasitic resistance (such as parasitic resistance 97) that causes a large voltage drop, which in turn lowers the effectiveness of the ESD protection mechanism. Moreover, as this type of ESD protection mechanism requires the power pad 95 or its path to be in the discharge path, the positioning in the circuit layout further affects the effectiveness of the ESD protection mechanism.

### SUMMARY OF THE INVENTION

Therefore, an object of the present invention is to provide an electrostatic discharge (ESD) protection circuit for protecting an internal circuit electrically coupled to an input/output (I/O) pad. The ESD protection circuit comprises an ESD protection unit coupled to the I/O pad, for releasing an electrostatic charge at the I/O pad to a ground terminal.

According to this invention, the ESD protection circuit also comprises a voltage detecting unit, electrically coupled to the ESD protection unit and the I/O pad, for detecting presence of an ESD voltage at the I/O pad and for controlling the ESD protection unit to establish a conduction path between the I/O pad and the ground terminal when the ESD voltage is detected.

Moreover, whether the ESD voltage is positive or negative, the ESD protection unit can direct the ESD voltage to the ground terminal, which shortens the discharge path and eliminates the need for a power pad.

### BRIEF DESCRIPTION OF THE DRAWINGS

Other features and advantages of the present invention will become apparent in the following detailed description of the preferred embodiments with reference to the accompanying drawings, of which:

FIG. 1 is a circuit diagram showing a conventional electrostatic discharge (ESD) protection circuit experiencing a negative ESD voltage;

FIG. 2 is a circuit diagram showing the conventional ESD protection circuit experiencing a positive ESD voltage;

FIG. 3 is a block diagram showing the first embodiment of the ESD protection circuit of the present invention;

FIG. 4 is a circuit diagram showing the second embodiment of the ESD protection circuit of the present invention;

FIG. 5 is a circuit diagram showing the third embodiment of the ESD protection circuit of the present invention;

FIG. 6 is a circuit diagram showing the fourth embodiment of the ESD protection circuit of the present invention;

FIG. 7 is a circuit diagram showing the fifth embodiment of the ESD protection circuit of the present invention;

FIG. 8 is a circuit diagram showing the sixth embodiment of the ESD protection circuit of the present invention; and

FIG. 9 is a circuit diagram showing the seventh embodiment of the ESD protection circuit of the present invention.

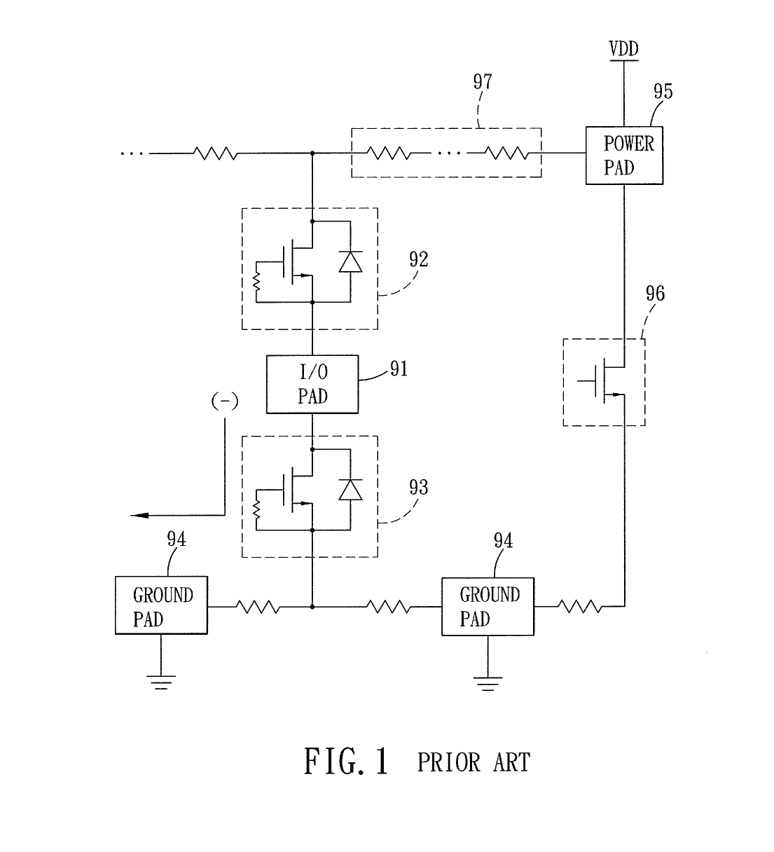

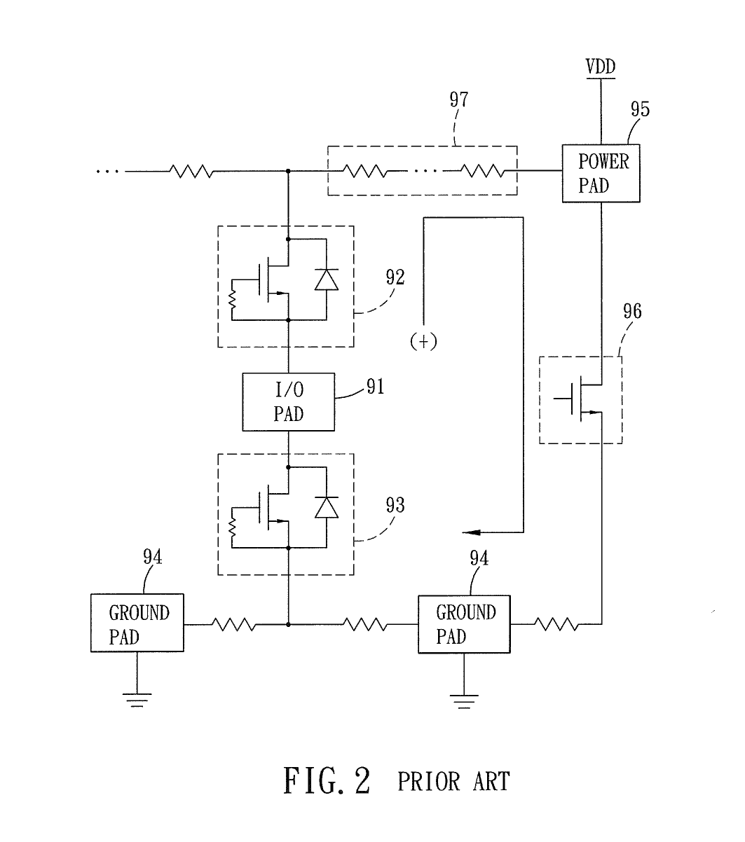

### DETAILED DESCRIPTION OF THE PREFERRED EMBODIMENTS

Before the present invention is described in greater detail, it should be noted that like elements are denoted by the same reference numerals throughout the disclosure.

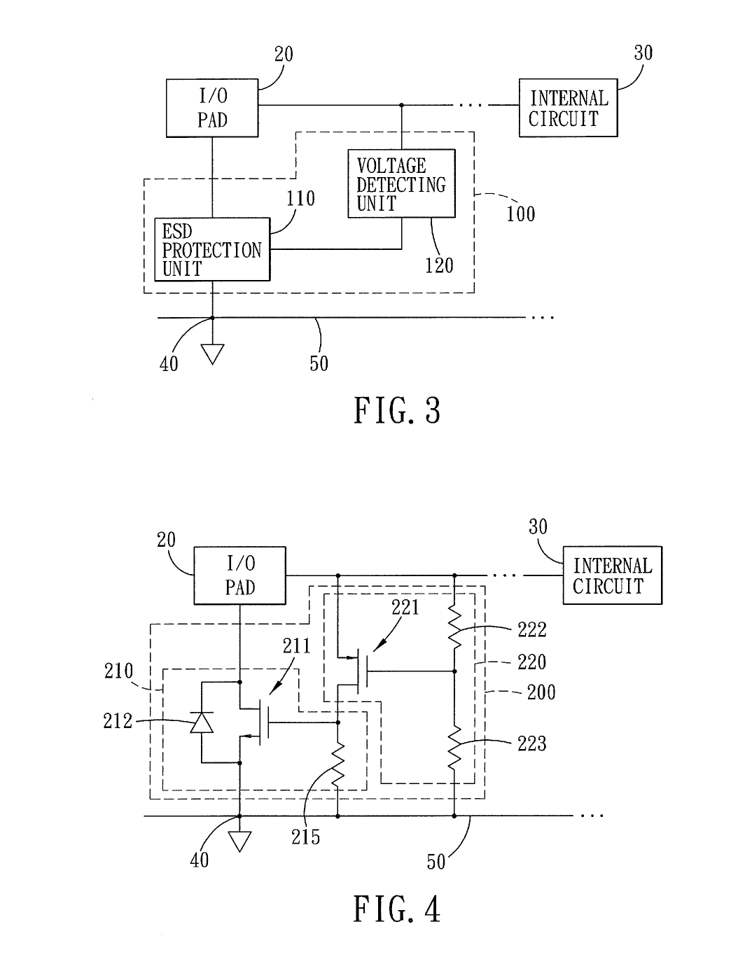

FIG. 3 shows the first embodiment of the electrostatic discharge (ESD) protection circuit 100 of the present invention. The ESD protection circuit 100 comprises an ESD protection unit 110 and a voltage detecting unit 120. The purpose of the ESD protection circuit 100 is to protect an internal circuit 30 electrically coupled to an I/O pad 20. When an ESD voltage occurs at the I/O pad 20, the ESD protection circuit 100 can protect the internal circuit 30 against the ESD current which may even cause damage to the internal circuit 30.

The ESD protection unit 110 is electrically coupled to the I/O pad 20 and a ground terminal 40. The function of the ESD protection unit 110 is to enable release of an electrostatic charge at the I/O pad 20 the ground terminal 40.

The voltage detecting unit 120 is electrically coupled to the I/O pad 20 and the ESD protection unit 110, and is used to detect presence of the ESD voltage at the I/O pad 20 and to control the operation of the ESD protection unit 110. Upon detection of the presence of the ESD voltage at the I/O pad 20, the voltage detecting unit 120 actively controls the ESD protection unit 110 to establish a conduction path between the I/O pad 20 and the ground terminal 40. The discharge path of the ESD voltage is shortened to more effectively protect the internal circuit 30 from being affected and damaged. Since the ESD voltage does not go through a power pad or path, the ESD protection circuit 100 will not be affected by the positioning of the power pad in the circuit, which promotes the protecting ability of the ESD protection circuit 100.

FIG. 4 shows the second embodiment of the ESD protection circuit 200 of the present invention. The ESD protection circuit 200 comprises an ESD protection unit 210 and a voltage detecting unit 220, which is electrically coupled to the ESD protection unit 210 and an I/O pad 20. The ESD protection unit 210 comprises a first transistor 211, which has a parasitic diode 212, and a first resistor 215.

The first transistor 211 has a drain electrically coupled to the I/O pad 20, a source electrically coupled to the ground terminal 40, and a gate electrically coupled to the voltage detecting unit 220. The first resistor 215 is electrically coupled between the gate and the source (or the ground terminal 40) of the first transistor 211. The first transistor 211 is preferred to be an N-type metal oxide semiconductor-field effect transistor. The parasitic diode 212 is between the drain and the source of the first transistor 211.

The voltage detecting unit 220 comprises a second transistor 221, a second resistor 222, and a third resistor 223. The second transistor 221 has a source electrically coupled to the I/O pad 20, a drain electrically coupled to the gate of the first transistor 211, and a gate electrically coupled to the second resistor 222 and the third resistor 223. The second transistor 221 is preferred to be a P-type metal oxide semiconductor-field effect transistor. The second resistor 222 is electrically coupled to the source and the gate of the second transistor 221. The third resistor 223 is electrically coupled to the gate of the second transistor 221 and the ground terminal 40. The second resistor 222 and the third resistor 223 form a voltage divider circuit among the I/O pad 20, the gate of the second transistor 221, and the ground terminal 40. In the operation of the ESD protection circuit 200, when a negative ESD voltage is present at the I/O pad 20, the negative ESD charge is directed to the ground terminal 40 via the parasitic diode 212 of the first transistor 211. The operation will prevent the ESD voltage from being directed into the internal circuit 30, which may damage the internal circuit 30. When a positive ESD voltage is present at the I/O pad 20, the divided voltage across the second resistor 222 causes the second transistor 221 to conduct. The positive ESD voltage acts on the source and the gate of the first transistor 211 through the first resistor 215, which causes the first transistor 211 to conduct and hence makes the ESD charge to be released directly to the ground terminal 40. The discharge path of the ESD voltage is shortened and, at the same time, the parasitic resistance created by the power routing 50 is lowered.

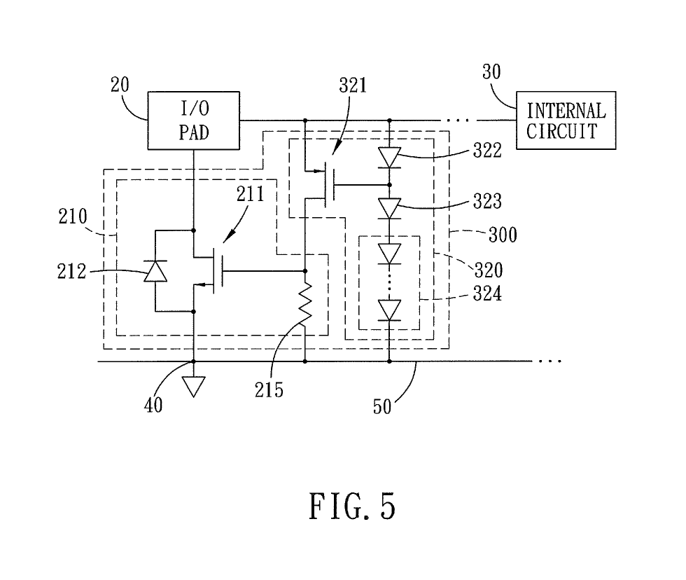

FIG. 5 shows the third embodiment of the ESD protection circuit 300, which comprises an ESD protection unit 210 and a voltage detecting unit 320 electrically coupled to the ESD protection unit 210 and the I/O pad 20.

The voltage detecting unit 320 comprises a second transistor 321, a first diode 322, a second diode 323 and a diode module 324. The diode module 324 comprises a third diode, or a plurality of series connected third diodes. The source of the second transistor 321 is electrically coupled to the I/O pad 20. The drain of the second transistor 321 is electrically coupled to the gate of the first transistor 211. The gate of the second transistor 321 is electrically coupled to the first diode 322 and the second diode 323. The second transistor 321 is preferred to be a P-type metal oxide semiconductor-field effect transistor.

The first diode 322 has of an anode electrically coupled to the source of the second transistor 321, and a cathode electrically coupled to the gate of the second transistor 321. The second diode 323 has an anode electrically coupled to the gate of the second transistor 321, and a cathode electrically coupled to the diode module 324. The diode module 324 has an anode electrically coupled to the cathode of the second diode 322, and a cathode electrically coupled to the ground terminal 40. In another embodiment where the diode module 324 is omitted from the voltage detecting unit 320, the cathode of the second diode 323 is electrically coupled to the ground terminal 40 directly.

In the operation of the ESD protection circuit 300, when a negative ESD voltage is present at the I/O pad 20, the ESD charge is directed to the ground terminal 40 via the parasitic diode 212 of the first transistor 211. When a positive ESD voltage is present at the I/O pad 20, the first diode 322, the second diode 323, and the plurality of third diodes in the diode module 324 all conduct in the same direction. The voltage drop at the first diode 322 causes the second transistor 321 to conduct. The ESD charge goes through the first resistor 215 to the gate and the source of the first transistor 211, which causes the first transistor 211 to conduct, such that the ESD voltage is released to the ground terminal 40.

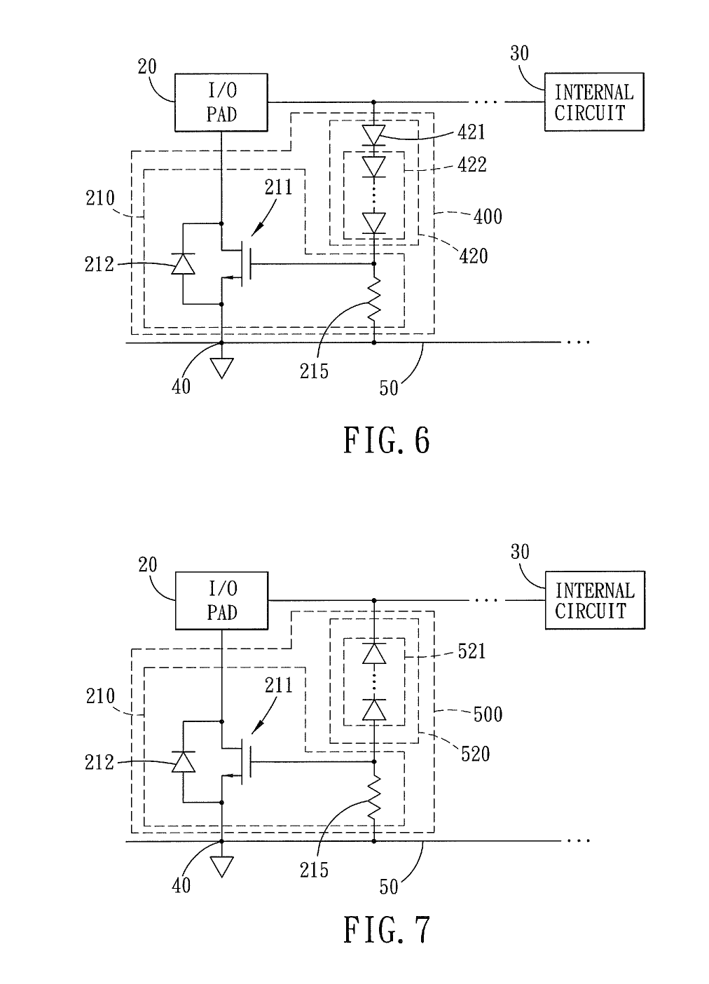

FIG. 6 shows the fourth embodiment of the ESD protection circuit 400 of the present invention, which comprises the ESD protection unit 210 and a voltage detecting unit 420 electrically coupled to the ESD protection unit 210 and the I/O pad 20.

The voltage detecting unit 420 comprises a first diode 421 and a diode module 422. The diode module 422 comprises a second diode, or a plurality of series connected second diodes. The first diode 421 has an anode electrically coupled to the I/O pad 20, and a cathode electrically coupled to the diode module 422. The diode module 422 has an anode electrically coupled to the first diode 421, and a cathode electrically coupled to the gate of the first transistor 211. In other embodiments, the diode module 422 can be omitted from the voltage detecting unit 420 where the cathode of the first diode 421 directly connects to the gate of the first transistor 211.

In the operation of the ESD protection circuit 400, when a negative ESD voltage is present at the I/O pad 20, the negative ESD charge is directed to the ground terminal 40 via the parasitic diode 212 of the first transistor 211. When a positive ESD voltage is present at the I/O pad 20, the first diode 421 and the plurality of the second diodes in the diode module 422 all conduct in the same direction. The positive ESD charge goes through the first resistor 215 to the gate and the source of the first transistor 211, which causes the first transistor 211 to conduct, such that the ESD voltage is released to the ground terminal 40.

FIG. 7 shows the fifth embodiment of the ESD protection circuit 500 of the present invention, which comprises the ESD protection unit 210 and a voltage detecting unit 520 electrically coupled to the ESD protection unit 210 and the I/O pad 20. The voltage detecting unit 520 comprises a diode module 521. The diode module 521 comprises a diode, or a plurality of series connected diodes. The diodes in the diode module 521 are preferred to be Zener diodes. The diode module 521 has a cathode electrically coupled to the I/O pad 20, and an anode electrically coupled to the gate of the first transistor 211.

In the operation of the ESD protection circuit 500, when a negative ESD voltage is present at the I/O pad 20, the negative ESD charge is directed to the ground terminal 40 via the parasitic diode 212 of the first transistor 211. When a positive ESD voltage is present at the I/O pad 20, the diodes in the diode module 521 undergo reverse breakdown. The positive ESD charge goes through the first resistor 215 to the gate and the source of the first transistor 211, which causes the first transistor 211 to conduct, such that the ESD voltage is released to the ground terminal 40.

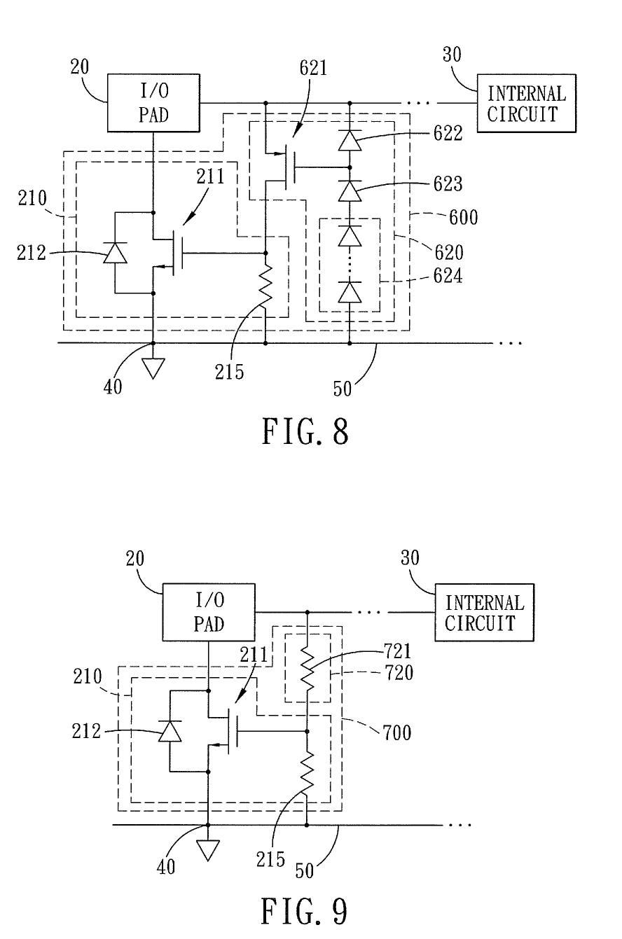

FIG. 8 shows the sixth embodiment of the ESD protection circuit 600 of the present invention, which comprises the ESD protection unit 210 and a voltage detecting unit 620 electrically coupled to the ESD protection unit 210 and the I/O pad 20.

The voltage detecting unit 620 comprises a second transistor 621, a first diode 622, a second diode 623 and a diode module 624. The diode module 624 comprises a third diode, or a plurality of series connected third diodes. The first diode 622, the second diode 623 and the plurality of series connected third diodes in the diode module 624 are preferred to be Zener diodes. The second transistor 621 has a source electrically coupled to the I/O pad 20, a drain electrically coupled to the gate of the first transistor 211, and a gate electrically coupled to the first diode 622 and the second diode 623. The second transistor 621 is preferred to be a P-type metal oxide semiconductor-field effect transistor.

The first diode 622 has a cathode electrically coupled to the source of the second transistor 621, and an anode electrically coupled to the gate of the second transistor 621. The second diode 623 has a cathode electrically coupled to the gate of the second transistor 621, and an anode electrically coupled to the diode module 624. The diode module 624 comprises a cathode electrically coupled to the anode of the second diode 623, and an anode electrically coupled to the ground terminal 40. In another embodiment where the diode module 624 is omitted from the voltage detecting unit 620, the anode of the second diode 623 is electrically coupled to the ground terminal 40 directly.

In the operation of the ESD protection circuit 600, when a negative ESD voltage is present at the I/O pad 20, the negative ESD charge is directed to the ground terminal 40 via the parasitic diode 212 of the first transistor 211. When a positive ESD voltage is present at the I/O pad 20, the first diode 622, the second diode 623, and the diodes in the diode module 624 all undergo reverse breakdown. The reverse breakdown voltage of the first diode 622 causes the second transistor 621 to conduct. The positive ESD charge goes through the first resistor 215 to the gate and the source of the first transistor 211, which causes the first transistor 211 to conduct, such that the positive ESD voltage is released to the ground terminal 40.

FIG. 9 shows the seventh embodiment of the ESD protection circuit 700 of the present invention, which comprises the ESD protection unit 210 and a voltage detecting unit 720 electrically coupled to the ESD protection unit 210 and the I/O pad 20. The voltage detecting unit comprises a second resistor 721. The second resistor 721 is electrically coupled to the I/O pad 20 and the gate of the first transistor 211. Therefore, the second resistor 721 and the first resistor 215 form a voltage divider circuit among the I/O pad 20, the gate of the first transistor 211 and the ground terminal 40.

In the operation of the ESD protection circuit 700, when a negative ESD voltage is present at the I/O pad 20, the negative ESD charge is directed to the ground terminal 40 via the parasitic diode 212 of the first transistor 211. When a positive ESD voltage is present at the I/O pad 20, the divided voltage of the first resistor 215 causes the first transistor 211 to conduct, allowing the positive ESD charge to be released directly to the ground terminal 40.

As described above, in the operation of the ESD protection circuits of the present invention, the ESD voltage can be released to the ground terminal 40 via the first transistor 211 whether the ESD voltage is positive or negative. Having the ESD voltage discharge path shortened prevents any unnecessary voltage drop, and avoids the necessity of an extra power pad or path. The releasing operations of the ESD protection units are controlled by the voltage detecting units. Whenever the voltage detecting units detect the presence of an ESD voltage at the I/O pad, they actively control the ESD protection circuits to direct the ESD voltage at the I/O pad to the ground terminal. The release of the ESD voltage to the ground terminal is therefore made even more effective, which also effectively protects the internal circuit from ESD damage.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electrostatic discharge (ESD) protection circuit for protecting an internal circuit coupled to an input/output (I/O) pad, the ESD protection circuit comprising:
an ESD protection unit, for releasing an electrostatic charge at the I/O pad to a ground terminal; and
a voltage detecting unit, for detecting presence of an ESD voltage at the I/O pad and for controlling the ESD protection unit to establish a conduction path between the I/O pad and the ground terminal when the ESD voltage is detected.

2. The ESD protection circuit as claimed in claim 1, wherein the ESD protection unit comprises:
a first transistor having a drain coupled to the I/O pad, a source coupled to the ground terminal, and a gate electrically coupled to the voltage detecting unit;
wherein when the electrostatic charge at the I/O pad is a positive charge, the first transistor conducts under the control of the voltage detecting unit so that the electrostatic charge is released to the ground terminal.

3. The ESD protection circuit as claimed in claim 2, wherein the ESD protection unit has a parasitic diode between the drain and the source of the first transistor; and
wherein when the electrostatic charge at the I/O pad is a negative charge, the electrostatic charge is released to the ground terminal through the parasitic diode.

4. The ESD protection circuit as claimed in claim 2, wherein the ESD protection unit further comprises:
a first resistor, coupled to the first transistor and the ground terminal;
wherein when the electrostatic charge at the I/O pad is a positive charge, a conduction voltage is formed at the gate of the first transistor via the first resistor under the control of the voltage detecting unit so as to cause the first transistor to conduct and thereby release the electrostatic charge to the ground terminal.

5. The ESD protection circuit as claimed in claim 4, wherein the voltage detecting unit comprises:
a second transistor, having a source coupled to the I/O pad, a drain coupled to the gate of the first transistor, and a gate;
a second resistor, coupled to the gate of the second transistor and the I/O pad; and
a third resistor, coupled to the gate of the second transistor and the ground terminal.

6. The ESD protection circuit as claimed in claim 4, wherein the voltage detecting unit comprises:
a second transistor, having a source coupled to the I/O pad, a drain coupled to the gate of the first transistor, and a gate;
a first diode, coupled to the gate of the second transistor and the I/O pad; and
a second diode, coupled to the gate of the second transistor and the ground terminal.

7. The ESD protection circuit as claimed in claim 4, wherein the voltage detecting unit comprises a first diode for coupling the gate of the first transistor to the I/O pad.

8. The ESD protection circuit as claimed in claim 4, wherein the voltage detecting unit comprises a second resistor for coupling the gate of the first transistor to the I/O pad.

9. An electrostatic discharge (ESD) protection circuit, for protecting an internal circuit electrically coupled to an input/output (I/O) pad, comprising:
a voltage detecting unit, for detecting presence of an ESD voltage at the I/O pad; and
an ESD protection unit, coupled to the voltage detecting unit and the I/O pad;
wherein when the voltage detecting unit detects the ESD voltage at the I/O pad, the voltage detecting unit controls the ESD protection unit to release an electrostatic charge of the ESD voltage to a ground terminal.

10. The ESD protection circuit as claimed in claim 9, wherein the ESD protection unit comprises:
a first transistor, having a drain coupled to the I/O pad, a source coupled to the ground terminal, and a gate coupled to the voltage detecting unit;
wherein the first transistor in the ESD protection unit conducts under the control of the voltage detecting unit so that the electrostatic charge is released to the ground terminal.

11. The ESD protection circuit as claimed in claim 10, wherein the ESD protection unit further comprises:
a first resistor, coupled to the gate of the first transistor and the ground terminal;
wherein when the electrostatic charge at the I/O pad is a positive charge, a conduction voltage is formed at the gate of the first transistor via the first resistor under the control of the voltage detecting unit so as to cause the first transistor to conduct and thereby release the electrostatic charge to the ground terminal.

12. An electrostatic discharge (ESD) protection circuit, for protecting an internal circuit coupled to an input/output (I/O) pad, comprising:
a voltage detecting unit, for detecting an ESD voltage at the I/O pad; and
an ESD protection unit, comprising a first transistor for releasing a positive electrostatic charge according to a detection of the voltage detecting unit and for releasing a negative electrostatic charge by a parasitic diode of the first transistor.
